(19) United States
(12) Patent Application Publication
(10) Pub. No.: US 2008/0022334 A1
(43) Pub. Date: Jan. 24, 2008

(54) Communication apparatus

(75) Inventors: Chikara Ushimaru, Tokyo (JP); Kazunobu Konda, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/802,025

(22) Filed: May 18, 2007

(30) Foreign Application Priority Data
Jul. 20, 2006 (JP) 2006-198458

(51) Int. Cl. H04N 7/173

(52) U.S. Cl. 725/98

(57) ABSTRACT

According to one embodiment, A communication apparatus for receiving content data obtained by sequentially receiving a broadcast wave to transmit the content data to a different communication apparatus the communication apparatus comprising: a communication section that communicates with the different communication apparatus through a network; a tuner section that receives the broadcast wave; and a presentation section that presents a content list to the different communication apparatus through the communication section, the content list including an item with respect to a channel receivable at the tuner section; wherein the item does not include an acquisition information for the different communication apparatus to acquire the content data.

### CROSS-REFERENCE TO RELATED APPLICATIONS

This application is based upon and claims the benefit of priority from Japanese Patent Application No. 2006-198458, filed Jul. 20, 2006, the entire contents of which are incorporated herein by reference.

### BACKGROUND

1. Field

One embodiment of the present invention relates to a communication apparatus for communicating with a different communication apparatus through a network.

2. Description of the Related Art

At present, development of DLNA (Digital Living Network Appliance) as a home network technology is advanced. In the DLNA, UPnP (Universal Plug and Play) is used as a constituent technology and particularly UPnP CDS is used as a constituent technology for releasing a content list of a list of content data provided by a server. Details of UPnP CDS are disclosed by following non-patent documents.

Kirt Debique and other six persons, “Content Directory:1 Service Template Version 1.01,” [online], Jun. 25, 2002, UPnP Forum, [search on Jul. 10, 2006], Internet (URL:http://www.upnp.org/standardizeddcps/documents/ContentDirectory1.0.pdf)

The CDS is a standard of defining a method for a player to acquire a content list of a list of content data that can be provided by a server, a method for a player to further acquire detailed information of content data contained in the content list, and the like. The detailed information of content data provided by the CDS is made up of title, class, genre, channel number, channel name, URI, communication protocol information, etc., in response to the type of content data. Particularly, the URI and the communication protocol information are often described regardless of the type of content data because they are used when the player acquires the content data.

Usually, to play back content data provided by the server, the player acquires a content list according to the CDS from the server, selects one piece of the content data out of the list, acquires the content data from the URI described as the content detailed information, and plays back the content data. Not only the content data stored in storage media included in the server, but also an item relating to live broadcast content data obtained in sequence by receiving a broadcast wave in a tuner if the server has the tuner can be contained in the content list described as the content data that can be provided by the server.

A server which does not have a function of transmitting live broadcast content data although it has a tuner, and has only a function of transmitting the content data stored in storage media also exists; usually such a server often does not release the live broadcast content data in the CDS.

However, the player may want to know information concerning channels that can be received by the server. For example, if the server has a timer-recording function and the player wants to give a timer-recording command to the server, the player needs to previously know information concerning the channels that can be received by the server, but if the server does not release information concerning the channels that the server can receive, the player cannot know the channel information.

On the other hand, if the server releases a content list containing information concerning the channels that can be received by the server as CDS, usually it also releases information of the URI, etc., but the server may have no function of transmitting live broadcast content data, because processing of encoding signals received in a tuner in sequence and executing streaming transmission to a different apparatus without recording the content data involves complicated management of buffering, etc. If the server is not compatible with transmission of live broadcast content data, the player cannot acquire the live broadcast content data if it accesses the URI, and thus an error, etc., may be caused to occur and interconnectivity may be impaired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a drawing to show the configuration of a communication system wherein a communication apparatus according to a first embodiment of the invention is used;

FIG. 2 is a chart to show a flow of processing when a content list and content data are acquired from the communication apparatus according to the first embodiment of the invention;

FIG. 3 is a block diagram to show the configuration of the communication apparatus according to the first embodiment of the invention;

FIG. 4 is a drawing to show a structure example of a content list provided by the communication apparatus according to the first embodiment of the invention;

FIG. 5 is a drawing to show an example of a content list presented by the communication apparatus according to the first embodiment of the invention;

FIG. 6 is a drawing to show an example of a content list presented by the communication apparatus according to the first embodiment of the invention;

FIG. 7 is a drawing to show an item example of a content list presented by a communication apparatus according to a modified example of the invention; and

FIG. 8 is a drawing to show an item example of a content list presented by the communication apparatus according to the first embodiment of the invention.

### DETAILED DESCRIPTION

Various embodiments according to the invention will be described hereinafter with reference to the accompanying drawings. In general, according to one embodiment of the invention, a communication apparatus for receiving content data obtained by sequentially receiving a broadcast wave to transmit the content data to a different communication apparatus, the communication apparatus comprising: a communication section that communicates with the different communication apparatus through a network; a tuner section that receives the broadcast wave; and a presentation section that presents a content list to the different communication apparatus through the communication section, the content list including an item with respect to a channel receivable at the tuner section; wherein the item does not include an acquisition information for the different communication apparatus to acquire the content data.

A communication apparatus of the invention will be discussed with reference to the accompanying drawings.

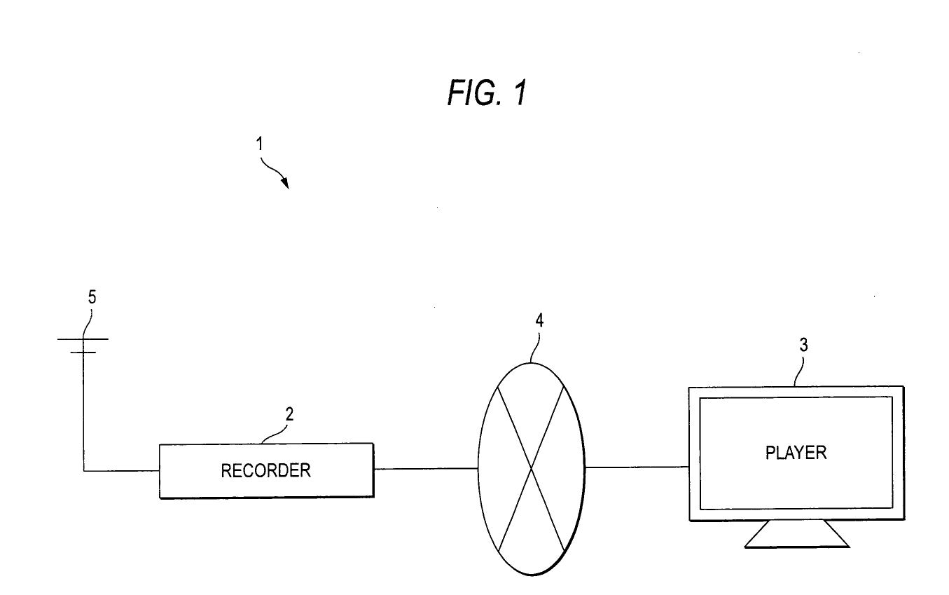

FIG. 1 is a drawing to show the configuration of a communication system wherein a recorder of a first embodiment of a communication apparatus of the invention is used. A communication system 1 is made up of a recorder 2 (communication apparatus) having a function of receiving and recording a broadcast wave and a player 3 (different communication apparatus). The recorder 2 and the player 3 are connected to a network 4 through which communications are conducted according to TCP (Transmission Control Protocol)/IP (Internet Protocol).

The recorder 2 is connected to an antenna 5 and has a function of receiving a broadcast wave input from the antenna 5 in a tuner section and recording the broadcast wave as mentioned above. The recorder 2 also has a function of transmitting recorded content data through the network 4 to the player 3.

It is assumed that the recorder 2 does not have a function of transmitting content data obtained in sequence by receiving a broadcast wave in the tuner section, namely, content data involved in the current live broadcast to the player 3 without recording on a record medium of an HDD, an optical disk, etc., although it has the function of transmitting recorded content data to the player 3. That is, if the user wants to view the current broadcast content with the player 3, he or she needs to view the content using a tuner other than the recorder 2.

The player 3 has a function of receiving and playing back content data recorded in the recorder 2 through the network 4 and outputting the content data to a display section and an audio output section of the player or an external display and an external audio output unit.

The recorder 2 and the player 3 are each an AV (Audio Visual) machine compatible with UPnP. The UPnP defines device, service, and control point as basic components of a network. The device is a machine compatible with UPnP and the service is the minimum unit representing a function provided by the device. Each device has at least one service. The control point controls and uses the service that the device has. Two or more device functions can also be included in one machine and further a machine having a control point and a device in one piece is also possible.

Further, specifications of UPnP AV Architecture are defined as specifications for UPnP AV machines. The UPnP AV Architecture defines UPnP Media Server Device (also called media server) as a server device in which a controlled function is implemented for providing content data. In the communication system 1, the recorder 2 functions as a media server. The recorder 2 of the embodiment of a media server provides CDS (Content Directory Service) of a service for releasing a content list and SRS (scheduled recording service) of a service for executing timer-recording.

Further, the UPnP AV Architecture defines UPnP Media Renderer Device (also called media renderer) as a playback device. In the communication system 1, the player 3 functions as a media renderer.

The player 3 functions as a media renderer as mentioned above and also has a function of controlling and using the service provided by the recorder 2 of a device as the function as a control point.

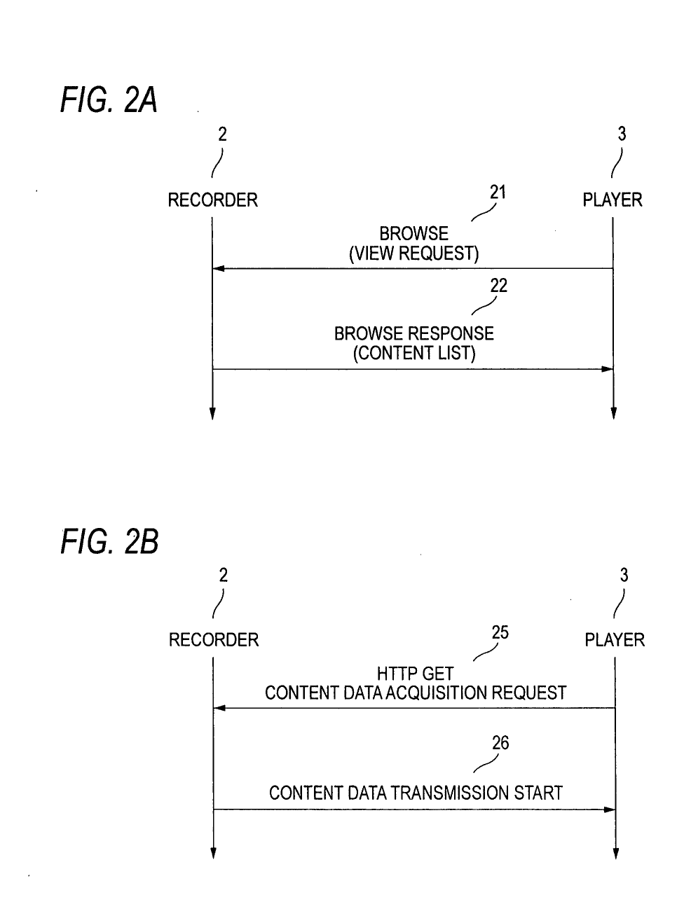

A general flow for the user to view content data retained in the recorder 2 using the player 3 of a digital TV, etc., will be discussed briefly with reference to FIG. 2.

FIG. 2 (a) is a chart to show a flow of processing when the player 3 acquires a content list from the recorder 2 of CDS, To begin with, the player 3 transmits a Browse request (view request) of an action of making a request for acquiring a content list to the recorder 2 as CDS (S21). Then, the recorder 2 transmits a content list as Browse Response (response to the request) (S22). Accordingly, the player 3 can acquire the content data that can be provided by the recorder 2 and its detailed information (for example, information of title, class, URI (Uniform Resource Identifier), communication protocol information, channel number, genre, etc.,).

In the example in FIG. 2 (a), the Browse request is used as the acquisition method of a content list, but the player 3 can also use a Search request to acquire a content list. In the description to follow, it is assumed that the player 3 uses a Browse request as an action of acquiring a content list, but the player 3 may use a Search request.

Next, a flow of processing when the player 3 acquires content data will be discussed with reference to FIG. 2 (b). FIG. 2 (b) is a chart to show a flow of processing when the player 3 acquires content data from the recorder 2.

The player 3 selects one piece of the content data out of the content list acquired in the above-described processing. The player 3 transmits an acquisition request of the content data to the URI described in the content list as the detailed information of the selected content data according to the communication protocol described as the detailed information (in the example in FIG. 2 (b), HTTP GET) (S25). The recorder 2 starts to transmit the content data to the player 3 as a response to the request (S26). Accordingly, the player 3 can play back video and audio by streaming playback, etc.

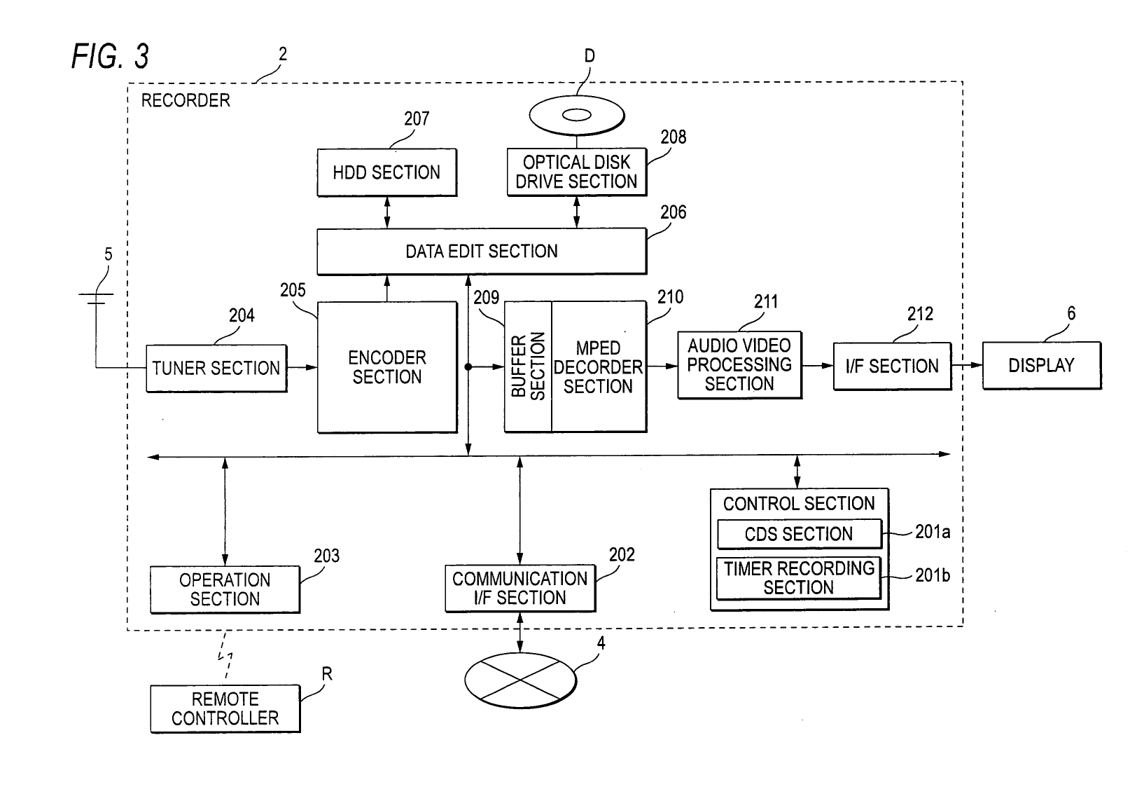

Next, the configuration of the recorder 2 will be discussed with reference to FIG. 3. FIG. 3 is a block diagram to show the configuration of the recorder 2. The recorder 2 is made up of a control section 201, a communication I/F section 202, an operation section 203, a tuner section 204, an encoder section 205, a data edit section 206, an HDD section 207, an optical disk drive section 208, a buffer section 209, an MPEG decoder section 210, an audio video processing section 211, and an I/F section 212. The control section 201, the communication I/F section 202, the operation section 203, the data edit section 206, and the buffer section 209 are connected through a bus.

The control section 201, which is a CPU (Central Processing Unit), etc., for example, executes a predetermined control program and controls the whole operation of the recorder 2. The control program executed in the control section 201 enables the recorder 2 to perform the function as a media server.

The executed control program also causes the control section 201 to function as a CDS section 201a (presentation section) for providing a content list for the player 3 as CDS and a timer-recording section 201b (recording section) for providing a timer-recording function for the player 3 as SRS.

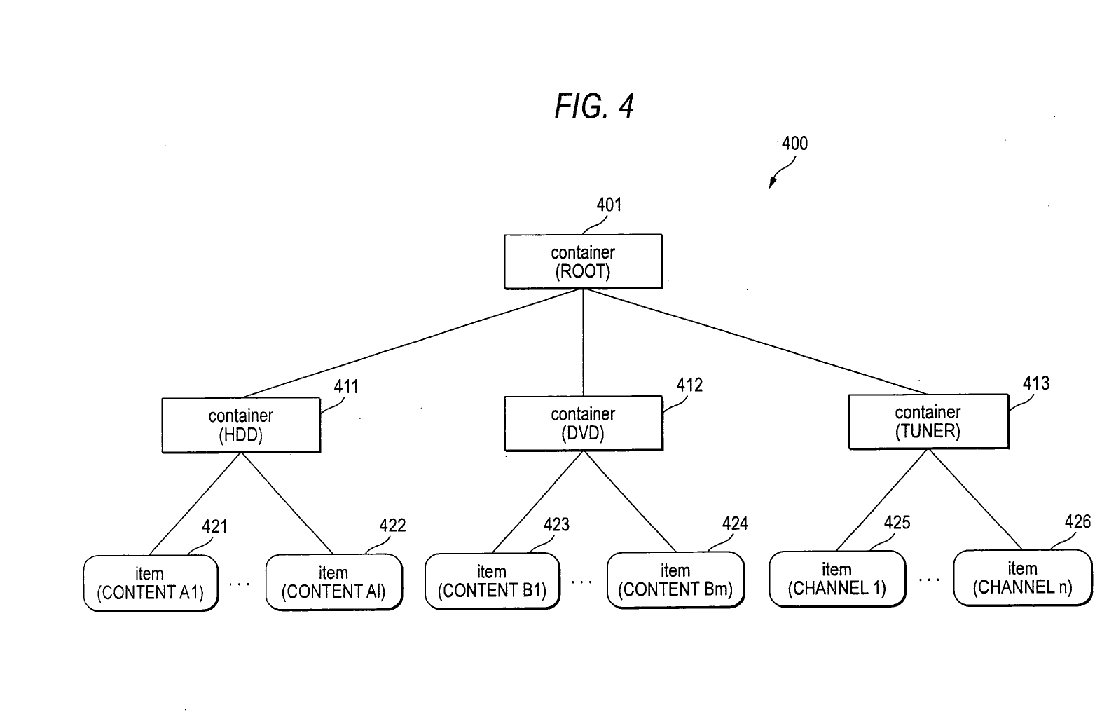

The CDS section 201a has a function of transmitting a content list in response to a request received from the player 3 as mentioned above. The details of the content list presented at this time are described later with reference to FIGS. 4 to 6. The CDS section 201a releases information concerning the channels that can be received in the tuner section 204 as items of the content list in the form in which the player 3 cannot acquire content data.

The timer-recording section 201b sets timer-recording based on a timer-recording request received from the player 3 (not shown in FIG. 3) through the communication I/F section 202 and records content data received and obtained in the tuner section 204 on the HDD section 207 or an optical disk D based on the timer-recording setting.

The communication I/F section 202 is a communication interface for conducting communications according to TCP/IP on the network 4 and receives a Browse request for making a request for viewing a content list (S21 in FIG. 2 (a)), a content data acquisition request (S25 in FIG. 2 (b)), a timer-recording request, etc., transmitted from the player 3. Likewise, Browse Response (S22 in FIG. 2 (b)), content data, and the like are transmitted from the communication I/F section 202 to the player 3.

The operation section 203 is a remote control signal light reception section, etc., for receiving a remote control signal from an operation button or a remote control R, for example, and is an input interface for user's operation and entry.

The tuner section 204 is connected to the antenna 5 for receiving satellite broadcast, terrestrial waves, etc., and outputting a signal to the encoder section 205. The encoder section 205 performs coding processing into a predetermined coding system of MPEG (Moving Picture Experts Group) format, etc., based on the signal output from the tuner section 204 and outputs the processing result to the data edit section 206.

The data edit section 206 has functions of writing content data created base d on the output from the encoder section 205 onto the HDD section 207 or the optical disk D and reading the content data from the storage media.

The recorder 2 has the two types of disk drives of the HDD section 207 and the optical disk drive section 208. The HDD (Hard Disk Drive) section 207 is a magnetic disk drive for writing content data onto a magnetic disk of an internal record medium at the recording time, etc., and reading the content data from the internal magnetic disk at the transmitting time of content data to the player 3 or the playback time of content data by the playback function of the recorder 2.

The optical disk drive section 208 rotates the optical disk D of a record medium and reads and writes data. Like the HDD section 207, the optical disk drive section 208 writes content data onto the optical disk D at the recording time, etc., and reads the content data from the optical disk D at the transmitting time of content data to the player 3 or the playback time of content data by the playback function of the recorder 2.

The recorder 2 further has the MPEG decoder section 210 for decoding the content data read from the HDD section 207 or the optical disk drive section 208 and output through the data edit section 206. When the MPEG decoder section 210 decodes the content data, the buffer section 209 temporarily stores the content data for buffering.

The audio video processing section 211 creates an audio signal and a video signal based on the signals output from the MPEG decoder section 210 and outputs the signals to a display 6 (not shown in FIG. 1) through the I/F section 212. The recorder 2 may contain an output unit corresponding to the display 6.

The recorder 2 according to the embodiment has the buffer section 209, the MPEG decoder section 210, the audio video processing section 211, and the I/F section 212 for providing the playback function as well as the timer-recording section 201b, the tuner section 204, and the encoder section 205 for providing the recording function. However, the recorder 2 need not necessarily have the playback function and may not necessarily have the buffer section 209, the MPEG decoder section 210, the audio video processing section 211, etc.

Subsequently, the content list provided by the CDS section 201a of the recorder 2 will be discussed with reference to FIGS. 4 to 6. The CDS section 201a manages information of content data according to a content list comprising containers and items. The item is defined as an XML (Extensible Markup Language) element for storing content data, and one piece of content data is represented by one item. On the other hand, the container is defined as a n XML element that can have an item and a container as subelement.

That is, compared to a general file system, the container corresponds a directory and the item corresponds to a file. The CDS section 201a manages the content data according to a tree structure having a special container of only one existing root container as a root.

FIG. 4 is a drawing to show a structure example of the content list provided by the CDS section 201a. A content list 400 shown in FIG. 4 has a container 401 as a root container. The container 401 has a container 411 for storing the items relating to content data stored on the HDD section 207, a container 412 for storing the items relating to content data stored on the optical disk D, and a container 413 for storing the items relating to the channels that can be received in the tuner section 204 as subelement.

The container 411 has items 421 to 422 provided in a one-to-one correspondence with pieces of content data recorded and stored on the HDD section 207 as subelement. Likewise, the container 412 has items 423 to 424 provided in a one-to-one correspondence with pieces of content data recorded and stored on the optical disk D that can be read by the optical disk drive section 208 as subelement.

The container 413 has items 425 to 426 provided in a one-to-one correspondence with the channels that can be received in the tuner section 204 as subelement. The CDS section 201a defines Browse (view request) of a viewing function and Search (search request) of a search function as actions for providing the content list 400 represented as a tree structure for the player 3 of a control point. The player 3 can acquire a content list by transmitting a Browse request or a Search request to the recorder 2 having the CDS section 201a.

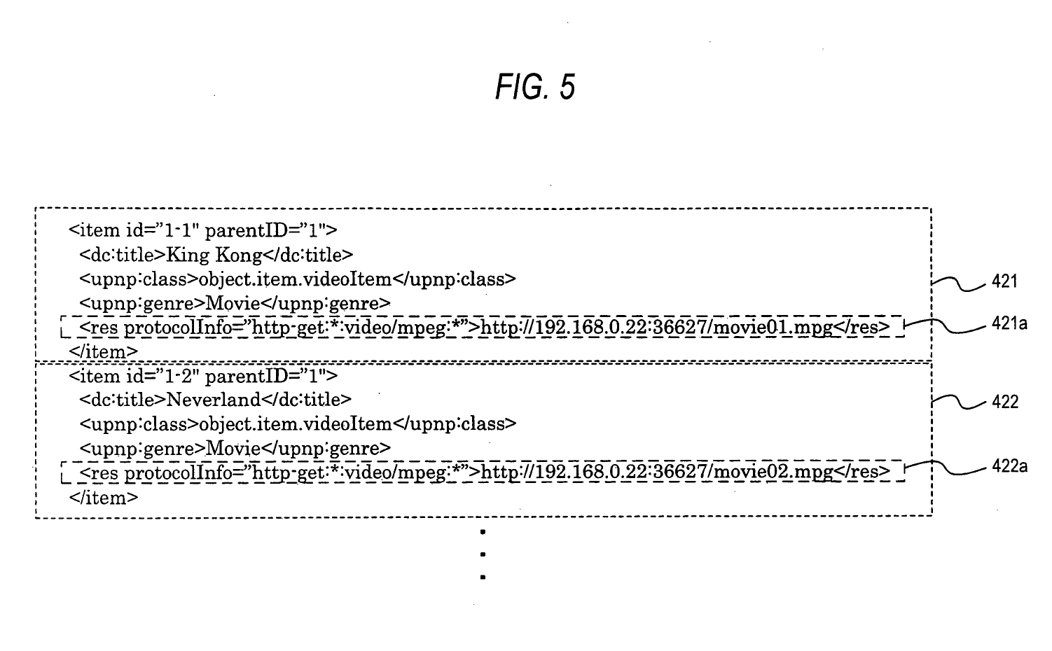

FIG. 5 is a drawing to show an example of a content list presented by the CDS section 201a upon reception of a Browse request for viewing an item under the container 411 corresponding to the HDD section 207 from the player 3. In the example in FIG. 5, two items of items 421 and 422 are described in the content list.

In the example in FIG. 5, item elements representing the items 421 and 422 have each a dc:title element describing title information, a upnp:class element describing class information, and a upnp:genre element describing genre information as subelements.

Each item element also has a res element describing resource information (also called acquisition information) as a subelement (the item 421 has a res element 421a and the item 422 has a res element 422a). In the res element, communiation protocol information (in the example of the item 421, “http-get:*:video/mpeg:*”) is described as protocolInfo attribute and URI information (also called location information; in the example of the item 421, “http://192.168.0.22:36627/movie0.1.mpg”) is described as sub-text. When playing back the content data corresponding to the item 421, the player 3 can transmit an acquisition request according to HTTP GET to the URI“:http://192.168.0.22:36627/movie0.1.mpg” based on the communication protocol information and the URI information, thereby acquiring and playing back the content data.

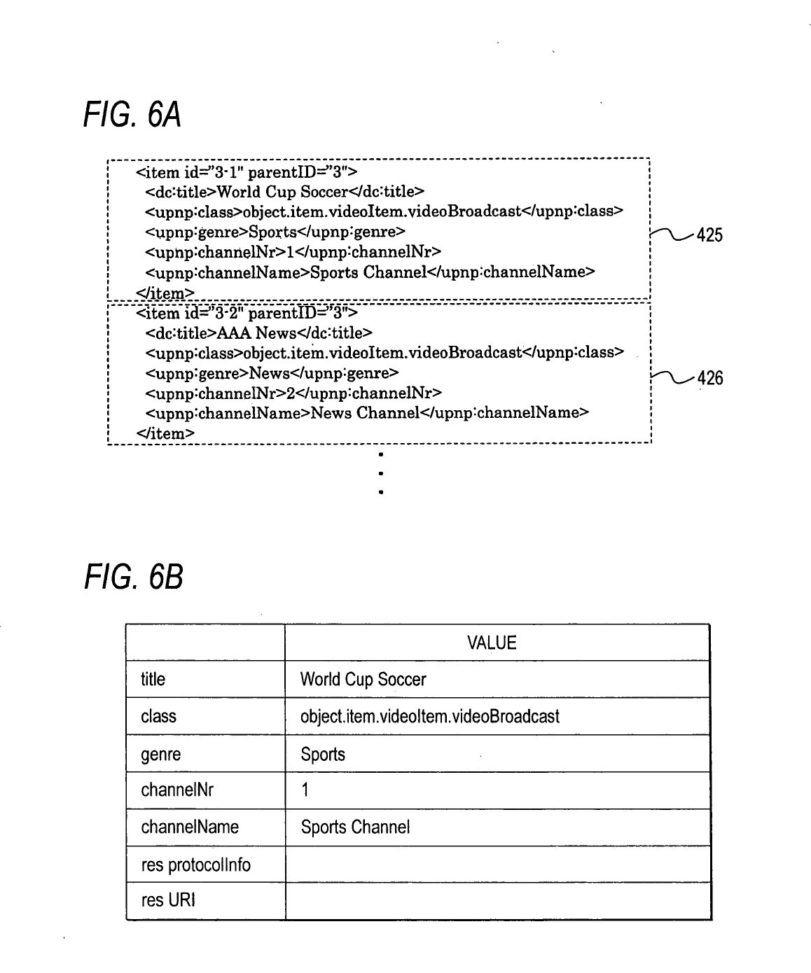

On the other hand, FIG. 6 (a) is a drawing to show an example of a content list presented by the CDS section 201a upon reception of a Browse request for viewing an item under the container 413 corresponding to the tuner section 204 from the player 3. In the example in FIG. 6 (a), two items of items 425 and 426 are described in the content list. FIG. 6 (b) is a drawing to schematically show information relating to the item 425.

In the example in FIG. 6, item elements representing the items 425 and 426 have each a dc:title element describing title information (in the example of the item 425, World Cup Soccer), a upnp:class element describing class information (in the example of the item 425, object.item.videoItem.videoBroadcast), a upnp:genre element describing genre information (in the example of the item 425, Sports), a upnp:channelNr element describing channel number (in the example of the item 425, 1), and a upnp:channelName element describing channel name (in the example of the item 425, Sports Channel) as subelements.

That is, the player 3 can acquire setup information and state of the channel numbers and the channel names of the channels that can be received in the tuner section 204 and the like by transmitting a Browse request for viewing the container 431 corresponding to the tuner section 204. That is, the player 3 can acquire information of the channel numbers and the channel names of the channels that can be recorded in the timer-recording section 201b as timer-recording and the like by sending a Browse request to the CDS section 201a. Since the user often uses the information of the channel numbers, the channel names, etc., at the setting time of timer-recording, the information is at least described, thereby aiding the user in timer-recording setting.

On the other hand, the item element does not have the res element describing the resource information (acquisition information) as a subelement. That is, the player 3 cannot know the URI information (res URI) or the communication protocol information (res protocolInfo) to acquire the content data that can be received in the tuner section 204. Since the player 3 cannot know the URI information or the communication protocol information although the recorder does not have a function of transmitting content data involved in live broadcast as described above, a defective condition of error occurrence, etc., caused by transmitting an erroneous acquisition request can be prevented from occurring and interconnectivity is not impaired.

In the present specifications, the channel released in CDS is defined so as to execute streaming of content data. However, for example, to execute timer-recording, streaming for the network 4 is not necessarily required and thus a method of releasing a channel list free of the streaming function becomes necessary. In the embodiment, while the content list relating to the channels is released, the resource information (acquisition information) is not described, so that receiving a streaming request from the player 3 is avoided while it is made possible to acquire a channel list involved in timer-recording.

In the embodiment, for the items relating to the channels that can be received in the tuner section 204, of the content list 400 provided by the CDS section 201a, neither the URI information (location information) nor the communication protocol information of the acquisition information is described as shown in FIG. 6, but the invention is not limited to the mode.

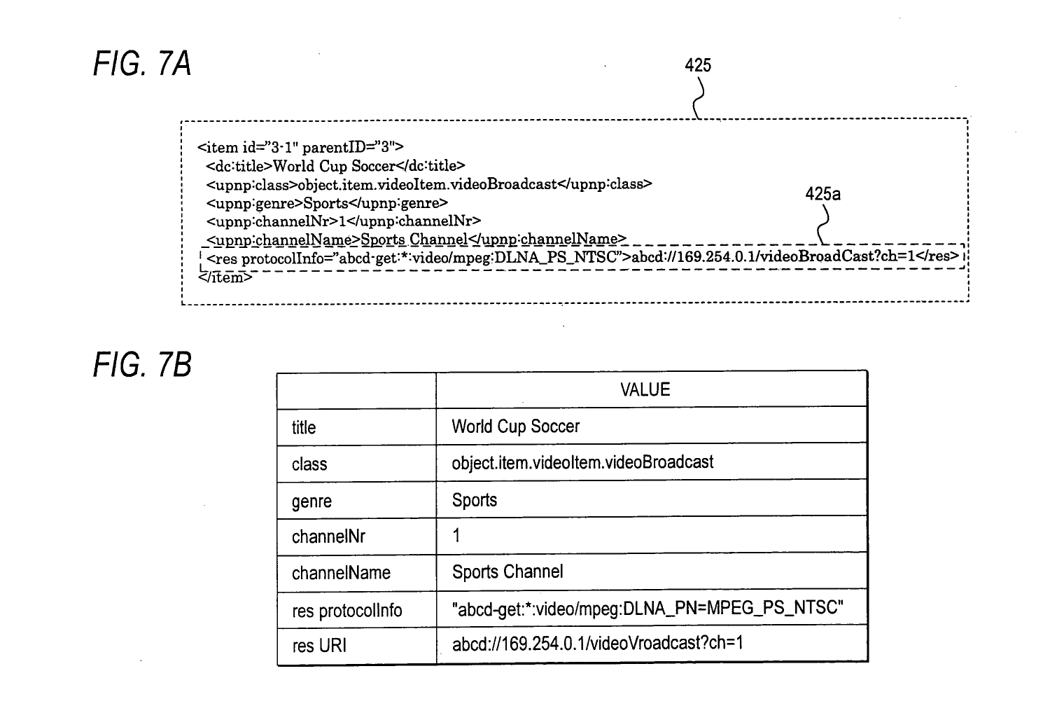

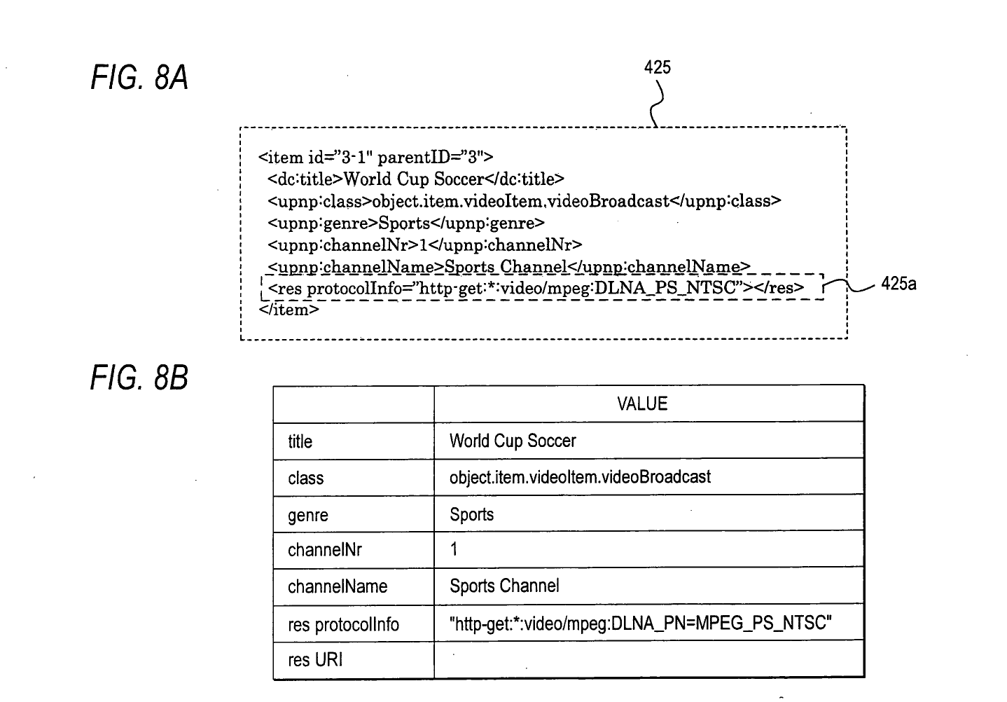

Different description examples for the items relating to the channels that can be received in the tuner section 204, of the content list 400 provided by the CDS section 201a will be discussed with reference to FIGS. 7 and 8.

FIG. 7 (a) is a drawing to show a description example of an item 425 according to a modified example. FIG. 7 (b) is a drawing to schematically represent detailed information relating to the description in FIG. 7 (a).

Also in the example in FIG. 7 (a), the item element representing the item 425 describes title information, class information, genre information, channel number information, and channel name information in subelements as in the example in FIG. 6.

However, in the example in FIG. 7 (a), the item element further has a res element 425a indicating acquisition information as a subelement. In the res element 425a, “abcd-get:*:video/mpeg:DLNA_PN=MPEG_PS_NTSC” is described as protocol information (res protocolInfo) and “abcd://169.254.0.1/videoBroadCast?ch=1” is described as URI information.

However, the communication protocol “abcd” is not a communication protocol standardized, etc., at present and the protocol information and the URI information are dummy data. That is, in the example in FIG. 7, the player 3 can acquire the protocol information and the URI information of acquisition information, but determines that the protocol information and the URI information are unknown and therefore the player 3 can be prevented from transmitting an acquisition request relating to the content data to the recorder 2. Accordingly, a defective condition of an error, etc., caused by transmitting an erroneous acquisition request by the player 3 can be prevented from occurring and interconnectivity is not impaired.

On the other hand, as in the example in FIG. 6, the player 3 can acquire the information concerning the channels that can be received in the tuner section 204, namely, the information of the channel numbers, the channel names, etc., of the channels that can be recorded in the timer-recording section 201b as timer-recording.

FIG. 8 (a) is a drawing to show a description example of an item 425 according to a second modified example. FIG. 8 (b) is a drawing to schematically represent detailed information relating to the description in FIG. 8 (a). Also in the example in FIG. 8 (a), the item element describes title information, class in formation, genre information, channel number information, and channel name information in subelements and also has a res element 425a as a subelement as in the example in FIG. 7.

However, unlike the example in FIG. 7, URI information is not described in the res element. On the other hand, protocol information relating to “HTTP GET” which actually exists, “http-get:*:video/mpeg:DLNA_PS_NTSC” is described as communication protocol information protocolInfo.

Accordingly, the player 3 can acquire the communication protocol information, but cannot obtain URI information to acquire content data. Accordingly, the player 3 cannot transmit an acquisition request of content data received in the tuner section 204 and a defective condition caused by transmitting the acquisition request can be prevented from occurring and interconnectivity is not impaired.

On the other hand, as in the examples in FIGS. 6 and 7, the player 3 can acquire the information concerning the channels that can be received in the tuner section 204, namely, the information of the channel numbers, the channel names, etc., of the channels that can be recorded in the timer-recording section 201b as timer-recording.

As described with reference to the embodiment, there is provided a communication apparatus capable of release information concerning a tuner without impairing interconnectivity.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A communication apparatus for receiving content data obtained by sequentially receiving a broadcast wave to transmit the content data to a different communication apparatus, the communication apparatus comprising:
a communication section that communicates with the different communication apparatus through a network;
a tuner section that receives the broadcast wave; and
a presentation section that presents a content list to the different communication apparatus through the communication section, the content list including an item with respect to a channel receivable at the tuner section; wherein the item does not include an acquisition information for the different communication apparatus to acquire the content data.

2. The communication apparatus according to claim 1, wherein the acquisition information contains at least one of a location information and a communication protocol information for the different communication apparatus to acquire the content data.

3. The communication apparatus according to claim 1, further comprising:
a recording section that records the content data on a storage medium,
wherein the communication section receives a timer-recording request from the different communication apparatus;
the recording section performs a timer-recording based on the timer-recording request; and
the presentation section presents information of the content data recorded on the storage medium to the different communication apparatus as the items.

4. The communication apparatus according to claim 2, further comprising:
a recording section that records the content data on a storage medium;
wherein the communication section receives a timer-recording request from the different communication apparatus;
the recording section performs a timer-recording based on the timer-recording request; and
the presentation section presents information of the content data recorded on the storage medium to the different communication apparatus as the items.

5. The communication apparatus according to claim 3, wherein the items contains information with respect to at least one of a channel number and a channel name.

6. The communication apparatus according to claim 4, wherein the items contains information with respect to at least one of a channel number and a channel name.

7. A communication apparatus for receiving content data obtained by sequentially receiving a broadcast wave to transmit the content data to a different communication apparatus, the communication apparatus comprising:
a communication section that communicates with the different communication apparatus through a network;
a tuner section that receives the broadcast wave; and
a presentation section that presents a content list to the different communication apparatus through the communication section, the content list including an item with respect to a channel receivable at the tuner section;
wherein the item includes a dummy data of a acquisition information for the different communication apparatus to acquire the content data.

8. The communication apparatus according to claim 7, wherein the acquisition information contains at least one of a location information and a communication protocol information for the different communication apparatus to acquire the content data.

9. The communication apparatus according to claim 7, further comprising:
a recording section that records the content data on a storage medium from the broadcast wave received in the tuner section;
wherein the communication section receives a timer-recording request from the different communication apparatus;
the recording section performs a timer-recording based on the timer-recording request; and
the presentation section presents information of the content data recorded on the storage medium by the recording section to the different communication apparatus as the items.

10. The communication apparatus according to claim 8, further comprising:
a recording section that records the content data on a storage medium from the broadcast wave received in the tuner section;
wherein the communication section receives a timer-recording request from the different communication apparatus;
the recording section performs a timer-recording based on the timer-recording request; and
the presentation section presents information of the content data recorded on the storage medium by the recording section to the different communication apparatus as the items.

11. The communication apparatus according to claim 9, wherein the item contains information with respect to at least one of a channel number and a channel name.

12. A communication apparatus for receiving content data obtained by sequentially receiving a broadcast wave to transmit the content data to a different communication apparatus, the communication apparatus comprising:
a communication section that communicates with the different communication apparatus through a network according to UPnP;
a tuner section that receives the broadcast wave; and
a presentation section that provides a CDS function to present a contents list to the different communication apparatus through the communication section, the contents list including an item element with respect to information of a channel receivable at the tuner section;
wherein the item does not include an acquisition information for the different communication apparatus to acquire the content data.

13. The communication apparatus according to claim 12, wherein the acquisition information of the item element includes a URI information or a protocol information.

14. The communication apparatus according to claim 12, wherein the acquisition information of the item element includes dummy data as a URI information and a protocol information.

15. The communication apparatus according to claim 12, further comprising:
a recording section that records the content data on a storage medium;
wherein the communication section receives a timer-recording request from the different communication apparatus;
the recording section performs a timer-recording based on the timer-recording request; and
the presentation section presents information with respect to the content data as the item element to the different communication apparatus.

16. The communication apparatus according to claim 15, wherein the item element contains information with respect to a channel number and a channel name.
